(19) United States
(12) Patent Application Publication
(10) Pub. No.: US 2024/0351254 A1
(43) Pub. Date: Oct. 24, 2024

(54) Structure Component

(71) Applicant: Weber Fibertech GmbH, 88677 Markdorf (DE)

(72) Inventor: Norbert STÖTZNER, Markdorf (DE)

(21) Appl. No.: 18/643,232

(22) Filed: Apr. 23, 2024

(30) Foreign Application Priority Data
Apr. 24, 2023 (DE) 20 2023 102 167.0

(51) Int. Cl. B29C 45/17; B29C 45/00; B29K 105/08; B29L 22/00

(52) U.S. Cl. CPC B29C 45/1704; B29C 45/0005; B29C 2045/1723; B29K 2105/08; B29L 2022/00

(57) ABSTRACT

A structure component which is produced by means of a fluid injection technique and has at least one first portion in which a hollow profile is provided and at least one second portion which is reinforced with continuous fibers.

The invention relates to a structure component, particularly a structure component for use in a motor vehicle, for example in a vehicle body.

Structure components are used in many areas and are regularly used to absorb and transmit mechanical forces. They can also be used to connect other components with one another. In many cases, the aim is to provide a structure component with high rigidity and low weight at the same time. This is particularly important in the area of lightweight construction, which is proving increasingly advantageous and is being used more and more frequently in many areas of technology.

Vehicles, particularly motor vehicles, can also be made lighter and more stable by using such structure components, without having to sacrifice comfort and safety.

In the vehicle sector, the use of structure components helps to reduce CO₂ emissions, among other things. In this area, structure components are used to protect components and assemblies. For example, flat, fiber-reinforced structure components can be used on the underside of a vehicle and then serve as underbody protection.

The publication DE 10 2017 110 906 A1 describes a structure component that is particularly configured for use in a vehicle body. The structure component has a first structure element which at least partially surrounds a spatial area, so that a hollow space is formed in the environment of the first structure element. This first structure element has a surface area delimiting this hollow space and a second structure element. A reinforcing element is also provided, which serves to mechanically reinforce the first structure element.

Fluid injection technology (FIT) is an umbrella term for methods in which hollow spaces are created by injecting a fluid. Fluid injection technology can be combined with injection molding, extrusion methods or any other suitable method. FIT is used in particular in connection with plastics, particularly polymer materials. In addition to the usual design features of plastic parts, this technique or process can be used to produce hollow profiles in the components, wherein this can be done at low cost. Due to the hollow geometry of the components, FIT components have a higher rigidity, while at the same time being lightweight and cost-efficient to produce.

Composite structures with continuous fibers are materials in which reinforcements with continuous fibers are combined with a matrix material. The sizes and properties are combined, resulting in a material with high stiffness and strength along the direction in which the fibers extend.

Processes are known in which hybrid molding is performed, wherein molding of an organic sheet and injection molding take place together in the injection mold. Such functional integration and the addition of ribbed structures result in greater structural strength.

The methods and processes known from the prior art are associated with a number of disadvantages. For example, the FIT method can only be used to process plastics or polymers with or without particles, short or long fiber reinforcement, but not with continuous fiber reinforcement. These materials have a lower stiffness and strength compared to composites with continuous fibers if the components, i.e. the reinforcement and the matrix, are the same. Although the hollow profile increases component rigidity many times over, the outermost layer of the material experiences the highest stress under the impact of mechanical loads. This is the weak point of the material itself at this location. In the FIT method, unreinforced, short-fiber-reinforced, i.e. up to 3 mm fiber length, or long-fiber-reinforced, i.e. from 3 mm fiber length, can be used. A combination with continuous filaments has not yet taken place.

In conventional hybrid molding methods, in which composites with continuous fibers, such as organic sheets, are combined with unreinforced polymers or polymers with short and/or long fibers, a hollow profile cannot be produced in a single step. Examples comprise an injection molding or compression molding process in which structural reinforcements, such as ribs, beads, etc., are added in addition to forming continuous fibers to increase component performance. Therefore, the weak point of reinforcements with continuous fibers lies in the geometric properties or features that are produced at an acceptable cost using these materials.

Against this background, a structure component with the features of claim 1 is presented. Embodiments are shown in the dependent claims and in the description.

The structure component presented is intended, for example, for installation or use in a motor vehicle. This structure component is produced by means of a fluid injection technique and has at least one first portion in which a hollow profile is provided and at least one second portion which is reinforced with continuous fibers.

The structure component can be constructed in such a manner that at least one first portion and at least one second portion are arranged relative to one another such that the at least one first portion is surrounded, at least in portions, by the at least one second portion.

The structure component can, for example, be designed as a hollow body comprising an inner cut-out hollow space and a wall, wherein the cut-out hollow space defines the hollow profile and the wall has the second portion with the continuous fibers.

The hollow profile can, for example, be created by a projectile propelled by water.

The continuous fibers can, for example, extend parallel and/or diagonally to a longitudinal axis of the hollow profile in an area on the outside of the wall.

A thermoplastic or thermoset plastic with or without reinforcement can be used for the structure component presented. Furthermore, continuous fibers can be used with or without matrix material. The continuous fibers can be integrated in the fluid injection step or after this step.

The present invention, which is embodied by the structure component presented, thus relates to the reinforcement of polymer or plastic components with a hollow profile or hollow cross-section using continuous fibers. The manufacturing process used and therefore the design of the components to be produced, wherein said method is used, is referred to as E-FIT, which is an acronym for Endless fiber composite and fluid injection technology.

Structure components produced using this E-FIT method have a higher mechanical performance due to both the composite material used with continuous fibers and the geometric features of the FIT components. For this reason, E-FIT parts and FIT components have an extremely high specific rigidity and strength, resulting in designs with low weight and low costs. Such E-FIT components can be used in the areas of automobiles, aviation and electric bicycles, but are not limited to these areas and can be used in a wide variety of applications.

It turns out that in many applications it is possible to achieve the desired design with low weight by combining composites that have continuous fibers with hollow channels.

The components produced in this manner have a higher mechanical performance, particularly in terms of rigidity and strength, due to the geometric features of the hollow profiles. Reinforcements with continuous fibers have a higher mechanical performance due to the material itself.

In this manner, the aspects of components with hollow profiles are connected to one another with reinforcements made of continuous fibers. This achieves maximum rigidity and high strength in the parts and components. The connection between the two aspects can be made in more than one step. Reference is made to FIG. 1.

It should be noted that any variant of fluid injection technology (FIT) can be used to produce a hollow profile or hollow cross-section for the structure component presented. Examples of this are a water injection technique and a projectile injection technique.

All polymers or plastics produced in a conventional plastic manufacturing process, such as injection molding, mold pressing, can be used for E-FIT, including thermoplastics and thermosets, with or without reinforcement. Short fibers or long fibers can be used for reinforcement.

Continuous filaments can be fibers with or without matrix material. Furthermore, fibers can be unidirectional, layered (layup) or multilayered in the designed orientation, as a laminate, woven or braided, etc. Reference is made to FIG. 3.

All kinds of materials can be used for continuous fibers, including glass, carbon, synthetic aramid fiber, natural materials, basalt fibers, etc.

Continuous fibers can be integrated during the FIT process. Alternatively, continuous fibers can be integrated after the FIT process, which requires an additional step.

It is understood that the features mentioned above and those to be explained below can be used not only in the combination indicated in each case, but also in other combinations or on their own, without going beyond the scope of the present invention.

Further advantages and embodiments of the invention are shown in the description and the accompanying drawing.

### BRIEF DESCRIPTION OF THE DRAWING

FIG. 1 shows a perspective representation of an embodiment of the structure component, which is intended for use in a motor vehicle.

FIG. 2 shows a section along line II in FIG. 1.

FIG. 3 shows two further structure components.

FIG. 4 shows another structure component in two representations.

FIG. 5 shows an open tool for the production of a structure component.

FIG. 6 shows a section along line VI-VI in FIG. 5.

FIG. 7 shows in a flow chart a possible sequence of the method presented for the production of one embodiment of the structure component.

FIG. 8 shows in a further flow chart a further possible sequence of the method presented for the production of a further embodiment of the structure component.

### EMBODIMENTS OF THE INVENTION

The invention is shown schematically by means of embodiments in the drawing and is described in detail below with reference to the drawing.

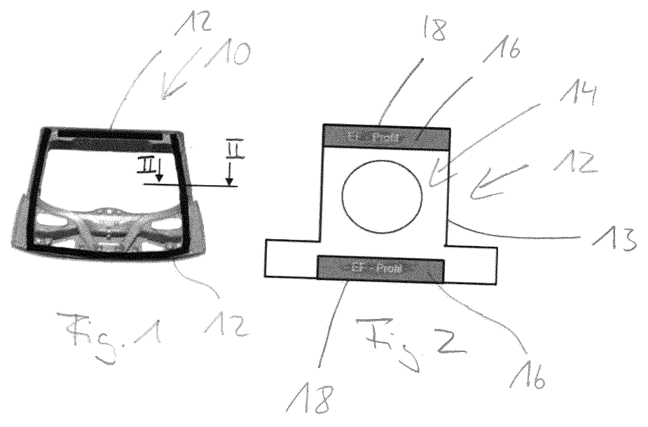

FIG. 1 shows a structure component 10 of a motor vehicle, wherein a plurality of structure segments 12 are accommodated in this structure component 10. These structural segments 12, which are made of a plastic material, are produced by means of an E-FIT method. This can be done in a one-step process.

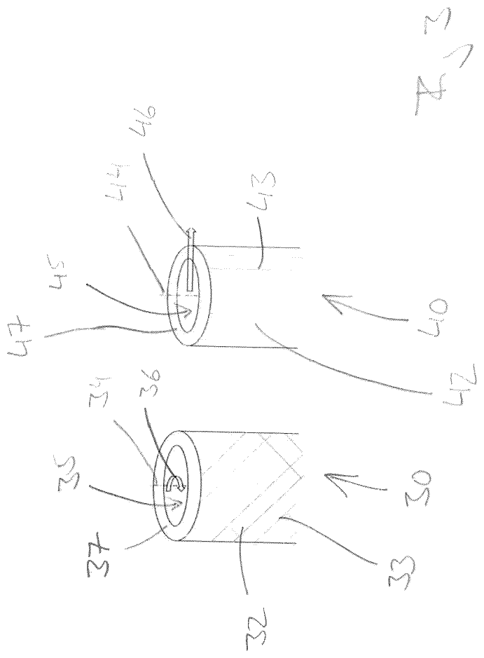

FIG. 2 shows a section along line II-II in FIG. 1. A hollow profile 14 can be seen in a first portion 13. At the upper end and at the lower end of the first portion 13, a profiling 16 is provided in each of two second portions 18 with continuous fibers.

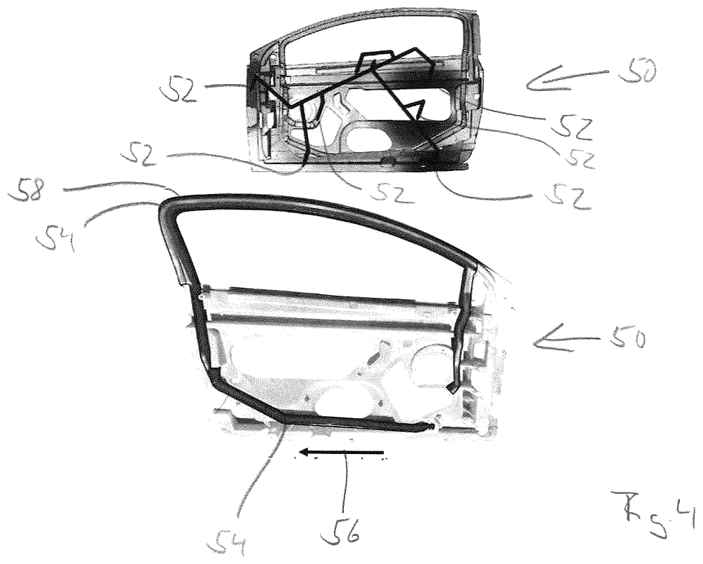

FIG. 3 shows a first structure component 30 and a second structure component 40. The two structure components 30, 40 are each constructed as a hollow body with a cut-out hollow space 35 or 45 and a wall 37 or 47 surrounding this hollow space 35 or 45 and have, on their outer surfaces or in the area of their outer surfaces on the wall 37 or 47, areas or second portions 32 or 42 which are reinforced with continuous fibers 33 or 43.

The portion 32 has endless fibers 33 which are aligned diagonally, for example at a 45° angle, with respect to a longitudinal axis 34 of the structure component 30 and overlapping or crossing one another. This orientation is particularly suitable for torsional loads, as illustrated by arrow 36.

In the second portion 42, on the other hand, the continuous fibers 43 are aligned parallel to the longitudinal axis 44 of the structure component 40. This is particularly suitable for a bending load, as illustrated by arrow 46.

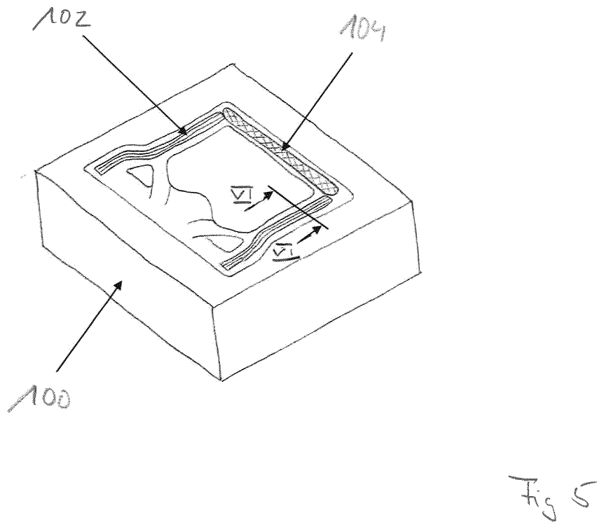

FIG. 4 shows another structure component 50, in this case a front side door, in two representations. The representation above illustrates a component design with six injection points 52 and a cascade for a cored U-profile. The representation shows a circular interrupted channel 54. An arrow 56 shows the direction of the long fiber orientation.

The representation illustrates the cold channel connection to surfaces of the structure component 50 and the partial filling via a cold channel 58. The surfaces are completely filled via the cold channel 58.

The method of production of the structure component 50 has a number of advantages, at least in some variations:
increase in rigidity,
increase in the strength target,
weight reduction of the structure,
functional integration,
cost reduction,
fully automatic manufacturing in very short cycle times,
can be completely recycled,
open-technology development.

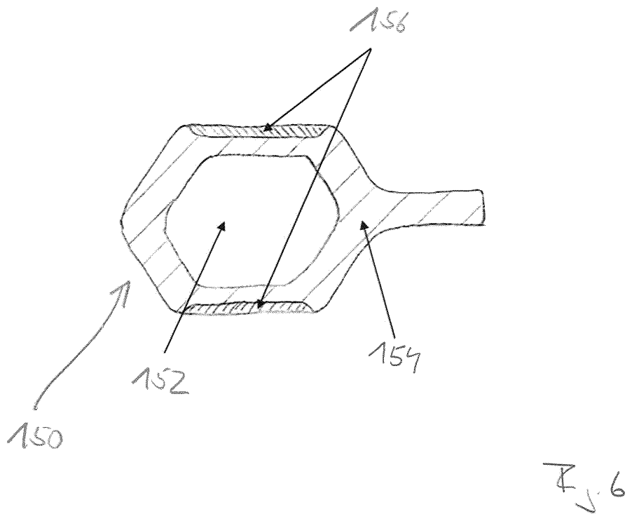

FIG. 5 shows an opened tool 100 with a first continuous fiber insert 102 and a second continuous fiber insert 104. After closing the tool 100, plastic reinforced with long or short fibers is inserted and the hollow profile is created by means of a fluid injection technique.

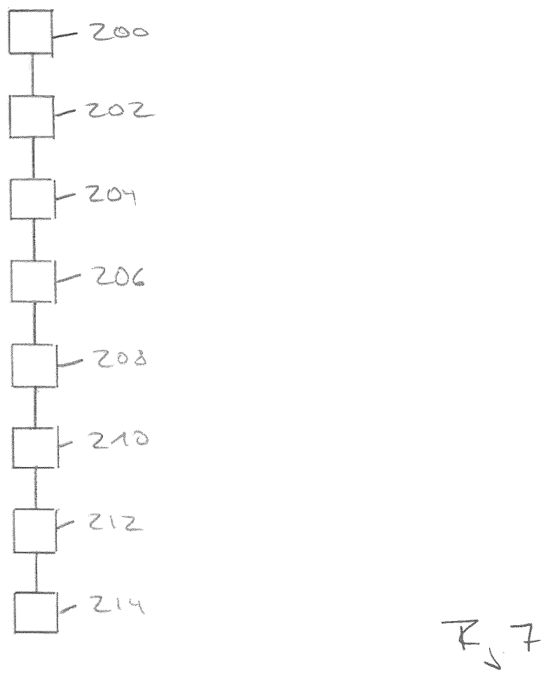

FIG. 6 shows a section along line VI-VI in FIG. 5. The representation shows a structure component 150 having a hollow profile 152, a first portion 154 of long or short fiber reinforced plastic and two continuous fiber inserts 156 forming the second portion.

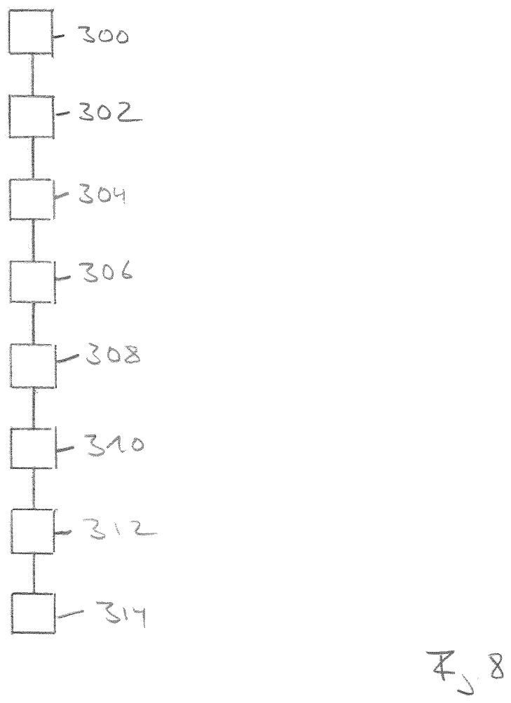

FIG. 7 shows in a flow chart a possible process for the production of a structure component of the type described herein using injection molding as an example.

In a first step 200, a tool is opened and, if necessary, a component is removed if one is present. Then, in one step, 202 continuous fiber inserts are stored in a positioned position. The tool is then closed in a step 204. A polymer reinforced with short or long fibers is then injected in a step 206 and a cavity in the tool is filled. In a step 208, a fluid is injected and the hollow profile is designed. The workpiece, the later structure component, then cools down in step 210. Once this has been done, the tool is opened in a step 212 and the structure component is removed in a step 214.

FIG. 8 shows in a further flow chart a further possible process for the production of a further structure component of the type described herein using the example of impact extrusion.

In a first step 300, a tool is opened and, if necessary, a component is removed if one is present. Then, in one step, 302 continuous fiber inserts are stored in a positioned position. A polymer reinforced with short or long fiber is then stored in a step 304. In a step 306, the tool is closed and a cavity in the tool is filled. In a step 308, a fluid is injected and a hollow profile is designed. The workpiece, the later structure component, then cools down in step 310. Once this has been done, the tool is opened in a step 312 and the structure component is removed in a step 314.

1-13. (canceled)

14. A structure component which is produced by means of a fluid injection technique and has at least one first portion in which a hollow profile is provided and at least one second portion which is reinforced with continuous fibers.

15. The structure component according to claim 14, wherein at least one first portion and at least one second portion are arranged relative to one another in such a manner that the at least one first portion is surrounded at least in portions by the at least one second portion.

16. The structure component according to claim 14, which is designed as a hollow body having an inner, cut-out hollow space and a wall with the second portion with the continuous fibers.

17. The structure component according to claim 14, wherein the hollow profile is produced by a projectile driven by water.

18. The structure component according to claim 14, wherein endless fibers extend parallel to a longitudinal axis of the hollow profile.

19. The structure component according to claim 14, wherein endless fibers extend diagonally to a longitudinal axis of the hollow profile.

20. The structure component according to claim 14, wherein endless fibers extend tangentially to the hollow profile.

21. The structure component according to claim 14, wherein the fluid injection technique is selected from a group consisting of: water injection technology, projectile injection technology, gas injection technology.

22. The structure component according to claim 14, wherein a thermoplastic or thermosetting plastic is used with or without reinforcement.

23. The structure component according to claim 14, wherein continuous fibers with or without matrix material are used.

24. The structure component according to claim 14, wherein the material for the continuous fibers is selected from a group consisting of: glass, carbon, synthetic aramid fiber, basalt fibers, natural material.

25. The structure component according to claim 14, wherein the continuous fibers are included in the fluid injection step.

26. The structure component according to claim 14, wherein the continuous fibers are integrated in a step after the fluid injection step.
